(19) United States
(12) Patent Application Publication
(10) Pub. No.: US 2010/0306591 A1
(43) Pub. Date: Dec. 2, 2010

(54) METHOD AND SYSTEM FOR PERFORMING TESTING ON A DATABASE SYSTEM

(76) Inventor: Murali Mallela Krishna, Vancouver, WA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/475,707

(22) Filed: Jun. 1, 2009

(51) Int. Cl. G06F 11/263; G06F 17/30

(52) U.S. Cl. 714/35; 707/E17.017; 714/E11.177

(57) ABSTRACT

There is provided a system and method for performing testing on a database system comprising a query optimizer, the query optimizer having an optimizer plan space comprising a plurality of query plans. An exemplary method comprises generating a plurality of queries programmatically according to a template query by varying at least one of an operation, a predicate or a parameter to produce a plurality of query plans. The exemplary method also comprises optimizing the plurality of queries using the query optimizer to collect the plurality of query plans and selecting a subset of queries from the plurality of queries using the query optimizer, the subset of queries comprising queries with distinct query plans that substantially cover the optimizer plan space. The exemplary method additionally comprises executing the subset of queries on the database system to identify an inefficiency of the database system.

### BACKGROUND

A modern relational database system comprises a very complex software environment. Such a system may be subject to an on-going process of optimization and performance improvement. A query optimizer is an important part of the database environment. The query optimizer attempts to determine a cost-effective strategy for obtaining the results to user queries. The cost to perform a query is a function of a search plan generated by the query optimizer. The search plan is an ordered set of operations such as join operations that are performed on tables to facilitate the query. The order in which join operations are performed may have a significant impact on the cost of a query. Overall database system performance may be seriously degraded if the query optimizer is not choosing cost-effective search plans.

It is desirable to perform regression testing when new code is introduced into the optimizer. For example, regression testing may be used to determine whether changes to query optimizer code have resulted in the unintended consequence of adversely affecting the optimizer's ability to choose low-cost search plans.

When changes to the optimizer code are made, a regression suite is applied to make sure that the changes have not adversely affected system performance. The regression suite comprises a series of test queries whose cost is known with respect to a previous state of the query optimizer. To determine if a change made to the query optimizer code has caused a regression, search plans created by the previous version of the query optimizer may be compared to the search plans generated for the test queries after the query optimizer code is modified. If the subsequent search plans are not at least as cost-effective as the previous search plans, it may be desirable to undo the changes to the query optimizer in order to remove the effects of the regression on system cost efficiency.

Although the query optimizer is an important part of a database system, the performance of regression testing for query optimizers remains a rather ad hoc process. Typically, a large number of SQL query suites are employed for the purposes of regression testing. These suites are often designed internally by development and/or quality assurance (QA) groups or are collected from various customers. Alternatively, industry-standard performance benchmarks may be used to measure database system performance. Examples of such industry-standard benchmarks include the TPC Benchmark™ H (TPC-H) promulgated by the Transaction Processing Performance Council (TPC) or the TPC Benchmark™ DS (TPC-DS), which is currently under development by the TPC.

While regression suites are useful in capturing regressions, optimizers frequently continue to require on-going bug fixes and patching. One contributing factor is that ad hoc regression suites do not necessarily provide effective coverage of the optimizer plan space. This is true, at least in part, because the process of developing an effective regression suite that effectively covers the optimizer plan space is a laborious and time-consuming process. After development of the regression suite, the time and effort needed to evaluate the results of regression testing may also be prohibitive from a practical standpoint. Over time, regression suites tend to grow larger, which only compounds the problem by lengthening both the testing process and the evaluation of test data.

In contrast, a regression suite that is small enough to significantly reduce test and evaluation times may not provide adequate coverage of the optimizer plan space. Lack of effective coverage may result in the optimizer producing ineffective plans for user queries. Moreover, smaller regression suites may not adequately cover the optimizer plan space.

Past efforts to improve regression testing include generating valid random SQL queries stochastically and running them on different database systems to verify the correctness of an existing system. Another known technique comprises creating random test cases for testing a query processor component with execution feedback. Other techniques employ tools that can generate a large number of SQL queries to test database systems.

Related work has been done in the development of regression testing for database applications. For example, a regression testing framework for database applications has been developed so that tests can be executed in parallel to scale linearly.

### BRIEF DESCRIPTION OF THE DRAWINGS

Certain exemplary embodiments are described in the following detailed description and in reference to the drawings, in which:

FIG. 1 is a block diagram of a database system that is adapted to perform regression testing on a database system according to an exemplary embodiment of the present invention;

FIG. 2 is a process flow diagram showing a method for performing regression testing on a database system according to an exemplary embodiment of the present invention; and

FIG. 3 is a block diagram showing a tangible, machine-readable medium that stores code adapted to facilitate the performance of regression testing on a database system according to an exemplary embodiment of the present invention.

### DETAILED DESCRIPTION OF SPECIFIC EMBODIMENTS

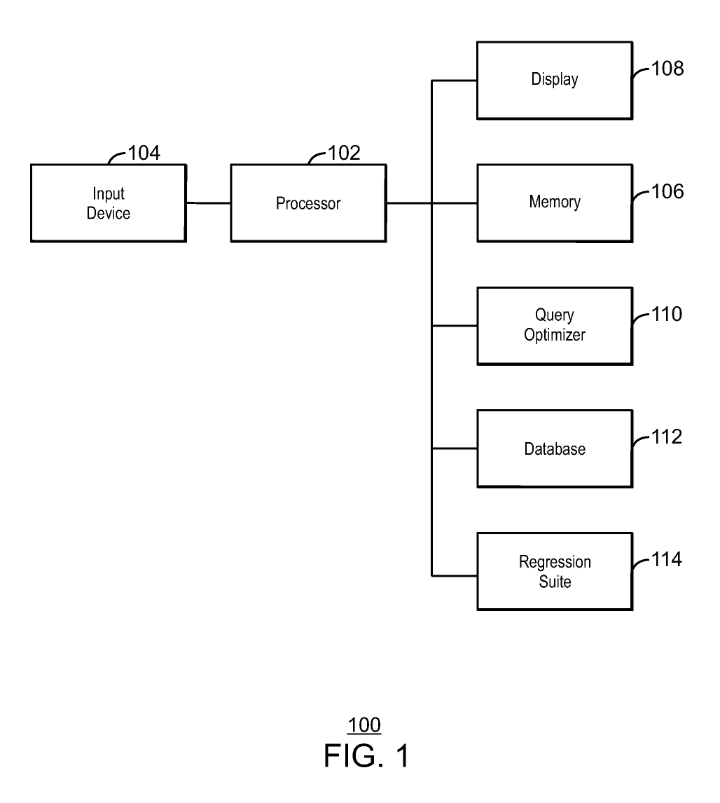

FIG. 1 is a block diagram of a database system that is adapted to perform regression testing on a database system according to an exemplary embodiment of the present invention. The database system is generally referred to by the reference number 100. Those of ordinary skill in the art will appreciate that the functional blocks and devices shown in FIG. 1 may comprise hardware elements including circuitry, software elements including computer code stored on a tangible, machine-readable medium or a combination of both hardware and software elements. Additionally, the functional blocks and devices of the database system 100 are but one example of functional blocks and devices that may be implemented in an exemplary embodiment of the present invention. Those of ordinary skill in the art would readily be able to define specific functional blocks based on design considerations for a particular electronic device.

A processor 102 controls the overall operation of the database system 100. Although only one processor 102 is shown in FIG. 1 for purposes of simplicity, those of ordinary skill in the art will appreciate that multiple processors may be used in an exemplary embodiment of the present invention. Moreover, exemplary embodiments of the present invention may comprise parallel database systems. The processor 102 receives input from an input device 104, which may comprise a keyboard, a mouse, a touch screen display or the like. The input device 104 may be used to provide a request for data (for example, a query) to the database system 100.

A system memory 106 may be used to store information that is used by the processor 102 during operation of the database system 100. In one exemplary embodiment of the present invention, the system memory 106 may comprise a volatile memory, a non-volatile memory, or some combination of the two depending on system design considerations. Moreover, the system memory 106 comprises an example of a tangible, machine-readable medium that stores computer-readable instructions. When machine-readable instructions are read from the system memory 106 and executed by the processor 102, the computer-readable instructions may cause the database system 100 to perform regression testing on a database system according to an exemplary embodiment of the present invention.

A display 108 is adapted to provide a visual representation of data corresponding to a physical system. For example, the display 108 may provide a visual representation of data that is produced by the database system 100 in response from a request by a user.

The database system 100 includes a query optimizer 110, a database 112 and a regression suite 114. In an exemplary embodiment of the present invention, the database 112 comprises a relational database such as a SQL database. The operation of the query optimizer 110, the database 112 and the regression suite 114 is explained in detail herein.

An exemplary embodiment of the present invention relates to the design of an efficient optimizer test suite that substantially covers the optimizer plan space. The test suite may be adapted to test a database system for inefficiencies. Examples of inefficiencies include regressions introduced by changes to the optimizer code or the like. An exemplary embodiment of the present invention may comprise systematically generating a small number of simple SQL queries such that their optimal search plans are distinct and cover a majority of the optimizer plan space. Equivalently, given a set of distinct plans, an exemplary embodiment of the present invention is adapted to find queries whose optimal plans map in 1-1 manner with the distinct plans.

An optimizer test suite such as a regression suite according to an exemplary embodiment of the present invention desirably covers most, if not all, search plan combinations for a given query, while maintaining a relatively small and simple structure. At least some queries may be run with alternate query plans to improve the chances that the optimizer is producing close to optimal plans. In addition, a simple metric may be used to compare regression suites so that quantitative differences between regression suites may be expressed.

Those of ordinary skill in the art will appreciate that the number of distinct queries that can be generated with even a small number of tables, say 10, can be too large to allow practical application of a regression suite. Moreover, this does not even take into account the numerous possibilities for the underlying schema of the tables in the regression suite. To provide effective coverage, the term “optimizer plan space” does not necessarily need to refer to the set of all possible optimal query plans for all legal SQL queries. Moreover, such a definition results in an infinite number of query plans. Accordingly, it may not be computationally feasible to cover the entire possible optimizer plan space. In accordance with an exemplary embodiment of the present invention, an optimizer plan space, OPS(PO, n), refers to the set of all possible patterns of n connected relational physical operators that can occur in any optimal plan for any valid SQL query.

In the expression OPS(PO, n), PO represents the set of physical operators that an optimizer uses to generate query plans. Physical operators are specific implementation methods (for example, table scan, index scan, hash join, sort group or the like) that occur in query execution plans. The variable n is a positive integer. As n grows larger, it becomes harder to generate a regression suite that covers OPS(PO, n). As used herein, a regression suite “covers” an optimizer plan space if, for substantially every pattern in OPS(PO, n), there is at least one query in the suite whose optimal plan exhibits that pattern in a connected region of the plan.

The following discussion addresses the combinatorial problems and some execution dependencies encountered when designing a regression suite. Some simplifying assumptions are then discussed. Thereafter, a plan space that may be used in accordance with an exemplary embodiment of the present invention is enumerated. Following the enumeration of the plan space, techniques for generating queries whose optimal plans correspond in a 1-1 fashion with enumerated plan choices discussed herein. Next, a method of choosing regression queries according to an exemplary embodiment of the present invention is discussed. In addition, a metric for measuring the performance of regression suites is set forth. Also discussed is a method of generating queries to cover a larger number of search plans according to an exemplary embodiment of the present invention.

The preparation of a regression suite according to an exemplary embodiment of the present invention takes into account a number of specific factors about the individual database system for which the regression suite is designed. Examples of factors that may be considered include the number of tables that are needed, the maximum number of tables in a regression suite query, the schema for the tables and the like.

Another factor is whether a large number of tables (for example, 20 tables or more) is better for purposes of regression testing than a relatively small number of tables (for example, about four tables). This determination relates to the tradeoff between search space coverage and computational feasibility. In addition, the shape of a query tree has an impact on memory requirements of a query when it is executed. Many query tree shapes are known to those of ordinary skill in the art. Examples of these query tree shapes include a zig-zag tree, a bushy tree, a left deep tree, a right deep tree and the like.

In designing a regression suite that tests costing functions of an optimizer, it is not necessarily true that a large number of tables produces better results than a query with fewer tables. This is true because a plan for a 20-table query may be thought of as being composed of a sequence of one, two or more join operations. In designing a regression suite according to an exemplary embodiment of the present invention, it is desirable to capture queries having plans that have distinct sequences of operators.

One exemplary embodiment of the present invention employs zig-zag plans (in other words, non-bushy plans). It is possible to trivially describe the signature of the non-leaf operators in a zig-zag plan with a linear string such as nested_join+hash_join+group_by. However, those of ordinary skill in the art will appreciate that the techniques described herein may be extended to bushy plans as well.

In general, query optimizers such as the query optimizer 110 are adapted to determine the logical and physical properties of an input and to decide on a physical implementation method for a given operator. This process is typically performed without taking into account what any of the previous operator methods were or what the future operator methods will be. This suggests that looking at a single operator in isolation should suffice for the purposes of operator costing. Yet, a sequence of hash joins as opposed to a sequence of nested joins would have significantly different memory requirements at run time. When a query is executing, there may be other dependencies between one sequence of operators and another sequence of operators with different implementations.

In order to capture at least some run time dependencies between operators while limiting the number of queries to generate, the maximum number of tables in a regression suite query may be restricted to a relatively small number, such as about four. This restriction is believed to be adequate for the purpose of designing a high quality regression suite because it enables an efficient design. The difficulty with increasing the number of tables is explained in greater detail below.

The following discussion relates to enumerating an optimizer plan space according to an exemplary embodiment of the present invention. As an example, consider the following four-table SQL query:
select T₁.a, max (T₄.b)
from T₁, T₂, T₃, T₄
where T₁.a=T₂.a and T₂.c=T₃.c and T₃.d=T₄.d
and pred₁ (T₁) and pred₂ (T₂) and pred₃ (T₃) and pred₄ (T₄)
group by T₁.a

The tables have selection predicates (pred₁ thru pred₄) on them. When choosing a plan for such a query, the optimizer may push the group operator below one or more joins. In addition, sort operators may be added to enable merge joins. The purpose of the single table predicates is to control the access path chosen for the base tables by controlling the selectivity of these predicates. Altering the selectivities of these predicates also controls the sizes of the tables participating in the joins, which will in turn dictate the choice of the join methods.

The number of executable query plans for the example query set forth above depends on the number of physical implementations that are available for each logical operator. A relatively simple enumeration scheme is set forth below. By way of example, assume that there are two different ways of accessing base tables, five different join methods, and two different grouping methods. These physical operators are listed below:

### Individual Tables Accesses:

S₁: table scan and S₂: index scan

### Joins:

J₁: cartesian product,
J₂: regular hash join (where one or both inputs have to be optionally partitioned on the fly)
J₃: small table broadcast hash join (here the smaller input is broadcast to all the sites/cpus of the bigger table),
J₄: merge join (where one or both inputs may be sorted), and
J₅: index nested loops join.

### Grouping:

G₁: hash group by and G₂: sort group by

In this example, differentiation between parallel and serial versions of the operators is not considered in order to keep the plan space manageable. Similarly, this example does not distinguish between different variants of joins such as semi, anti, and outer joins.

Considering only zig-zag plans, the four tables can be arranged in 4!=24 ways in a query plan. Each of the four table scans can be done in two different ways while one of five join methods can be chosen for each of the three joins. The group by operator can be placed below 0 or more joins and can be implemented in two different ways. The number of zig-zag plans is roughly (4!)*(2⁴)*(5³)*(4*2)=384,000.

Those of ordinary skill in the art will appreciate that not all 384,000 different query plans are feasible. For example, when doing a nested loops index join, an index lookup on the inner table will be used rather than a sequential scan on the inner table. This set of non bushy plans is a subset of OPS({S1, S2, J1, . . . , J5, G1, G2}, 8) since there are four accesses, three join operations, and one group operation. Certain subtleties may be ignored, for example, not accounting for some sorts that may be added before merge joins or the fact that sometimes the group operation is split into more than one phase.

It is desirable to generate queries whose optimal plans correspond to each of the roughly distinct 384,000 plans. In addition, it may be feasible to reduce the number of queries without compromising the quality of a regression suite according to an exemplary embodiment of the present invention. One manner to reduce the number of needed queries is to make an assumption that the order in which tables are joined is not important. If the optimizer chooses the correct single table access path, then the specific table that occurs at a particular level is not important.

According to an exemplary embodiment of the present invention, if the number of rows from each table that participate in a query is known, then four different instances of a single table may be used instead of four different tables. This simplification results in the need to design a schema for a single table only, reducing the number of query plans by a factor of 4!(384,000/(4!)=16,000 query plans). Joining different instances of the same table with itself may introduce correlations that do not exist in the original data. If this is a concern, copies of the table can be made. Each copy of the table will have the same values in column b but in a different random order.

The exemplary query set forth above then takes the following form:
select T₁.a, max (T₄.b)
from T T₁, T T₂, T T₃, T T₄
where T₁.a=T₂.a and T₂.c=T₃.c and T₃.d=T₄.d
and T₁.b≦C₁ and T₂.b≦C₂ and T₃.b≦C₃ and T₄.b≦C₄
group by T₁.a
where 1≦Cᵢ≦|T|, 1≦i≦4.

The predicates pred₁ thru pred₄ may be replaced with actual selection predicates. Column b can be a unique column, giving a fine degree of control on the number of rows participating from each table.

The revised query may be referred to as a template skeleton query. All the queries in a regression suite according to an exemplary embodiment of the present invention may have this basic format. Choosing the right skeleton query and the physical properties of the underlying table carefully will play an important role in the number of query plans captured. A large number of choices exist for selecting a skeleton query and the schema of T. Accordingly, it is desirable to select a schema that will work well for purposes of generating an effective regression suite.

In one example that has been evaluated, Table T has 8,388,608 rows in it and its schema is as follows:
T (int a, int b, int c, int d)
a: primary clustering key, hash partitioned 8 ways on column ‘a’
b: unique random secondary key
c: Beta (4, 4): integer-valued, Normal-like over [1, 8388608] with mean=4194419, std. dev=1398131
d: Beta (2, 0.5): integer-valued, Zipfian-like over [1, 8388608] with mean=6711152, skew=−1.25

In this exemplary Table T, column ‘a’ has a primary index on it, while all the other columns have secondary indexes (for enabling index joins). Using different distributions, some with skew, provides for a better test of the cardinality and costing modules of the optimizer and also the execution engine. An important goal is to capture more plans for the regression suite.

Next, regression queries are generated according to an exemplary embodiment of the present invention. Those of ordinary skill in the art will appreciate that regression queries may be generated according to multiple techniques. A goal is to generate at least one query having an optimal plan that corresponds to one of the approximately 16,000 plans enumerated in the example set forth above.

To reduce the number of queries generated even more (if desired), further assumptions may be made. One assumption is that it is not needed to focus on single table access path selection. This assumption is possible if the optimizer is known to have an acceptable rate of picking the access path for base tables. Under this assumption, the number of possible search plans is reduced by a factor of 2⁴ (16,000/(2⁴)=1,000 query plans). This corresponds to the non bushy subset of OPS({J1, . . . , J5, G1, G2}, 4), since three joins and one group by operation are being considered.

A second simplifying assumption may be made by considering only joins and not the group operator. This assumption is based on the observation that join costing and ordering is one of the more significant aspects of finding an acceptable query plan. In addition, not considering the group operator makes it easier to compare the quality of regression suites using well-known metrics such as TPC-H or TPC-DS. This is true because multi-table queries intrinsically involve joins but do not always include a group operation.

Under these two simplifying operations, the modified skeleton query becomes:
select T₁.a
from T T₁, T T₂, T T₃, T T₄
where T₁.a=T₂.a and T₂.c=T₃.c and T₃.d=T₄.d
and T₁.b≦C₁ and T₂.b≦C₂ and T₃.b≦C₃ and T₄.b≦C₄
   For the simplified skeleton query, the number of possible plans reduces to 1,000/(4*2)=125=5³. Even though the number of possible search plans is reduced dramatically from about 384,000 to about 125 according to an exemplary embodiment of the present invention, a regression suite so developed is relatively effective at covering the optimizer join plan space. Those of ordinary skill in the art will appreciate that techniques described herein for reducing the number of search plans are discretionary and are elaborated herein for the purpose of showing that exemplary embodiments may be performed with fewer search plans when fewer computational resources are available. Moreover, the reduction of the number of search plans is not an essential feature of the invention. Any number of search plans may be used, depending on the availability of computing resources to evaluate the search plans.

Starting from the skeleton query, the next task is generating up to 125 different queries, whose optimal plans correspond to one of the 125 different potential join plans. Starting from J₁-J₁-J₁, these plans can be enumerated up to J₅-J₅-J₅. Going back to the earlier definition of optimizer plan space, it is desirable to cover the non-bushy subset of OPS({J1, . . . , J5}, 3), where the only operator of interest is the join operator.

One method of generating up to 125 different queries with distinct join plans is to develop them manually. Given knowledge of a specific optimizer's cost functions, this is perhaps feasible for an optimizer expert, although it would likely be a lengthy and tedious process. Moreover, it would be desirable to be able to develop queries for any commercial optimizer and database engine without hiring an expensive expert.

According to an exemplary embodiment of the present invention, the optimizer is allowed to select queries with distinct plans according to a template query. The query plans may be generated by varying at least one of an operation, a predicate or a parameter of the template query. Examples of operations that may be varied include a scan operation, a join operation, a group by operation or any other database operator depending on the template query.

In one exemplary embodiment of the present invention, a large number of queries may be generated programmatically by varying the constants C₁ thru C₄. These generated queries may be delivered to the optimizer, which will in turn generate the distinct plans and the corresponding queries. A high quality skeleton query will desirably yield a large number of distinct plans.

In addition to varying C₁ thru C₄, it would be desirable to vary the join cardinalities also. This process is complicated by the need to change the underlying data and schema of the table T on a per query basis, leading to a schema explosion problem. Nonetheless, the variety of distributions on the various join columns may provide a correspondingly wide range of join cardinalities. Moreover, acceptable results can be obtained by varying the input cardinalities of the base tables that participate in the joins.

Varying the cardinalities of the participating tables allows an exemplary embodiment of the present invention to cover the cardinality space, which in turn is likely to substantially cover the plan space by letting the optimizer choose among the various join implementations. This is why a regression suite according to an exemplary embodiment of the present invention provides good coverage of the optimizer plan space.

An exemplary embodiment of the present invention has been evaluated using the following set of five values for each Cᵢ: {1, 100, 10000, 1000000, 4000000}=CardSet₁. This resulted in generating 5⁴=625 queries which were delivered to a query optimizer, such as the query optimizer 110. After collecting the plans for these queries, it was determined that 19 distinct join plans were created out of a total of 125 total join plans. Next, the base table cardinality values were increased by choosing from the following set: {1, 10,100,1000,10000,100000,1000000, 2000000, 4000000, 8000000}=CardSet₂.

In one experiment, the 10,000 generated queries yielded 42 distinct join plans. More distinct join plans may be created with an improved skeleton query. The performance of some optimizers may foreclose getting close to the 125 desired distinct plans. Moreover, some optimizers may choose among a smaller set of plans that are close to optimal rather than trying to choose among a very wide range of plans. For example, it may be expected that hash joins will dominate once the cardinalities exceed a certain threshold.

In one experiment, it was observed that some types of join plans were not created. Moreover, no plan developed in this experiment had a sequence of three merge joins. It was observed that only the first join predicate (T₁.a=T₂.a) had matching sorted columns. This suggests that some additional queries whose plans are known may be developed manually and added to the regression suite. For example, the query below has an optimal plan sequence of three merge joins:
select T₁.a
from T T₁, T T₂, T T₃, T T₄
where T₁.a=T₂.a and T₂.a=T₃.a and T₃.a=T₄.a and
T₁.b≦C₁ and T₂.b≦C₂ and T₃.b≦C₃ and T₄.b≦C₄
   Thus, the manual creation of some queries may also be useful.

According to an exemplary embodiment of the present invention, it may be possible to more effectively choose the cardinality values for C₁ thru C₄ in terms of achieving more distinct plans. This depends on the internal cost functions of a specific optimizer.

The following discussion relates to constructing a regression suite such as the regression suite 114 according to an exemplary embodiment of the present invention. For each of the 42 distinct join plans, it is desirable to pick one or more representative queries from the set of 10,000 to place into the regression suite 114. The constants {C₁, C₂, C₃, C₄} form a four-dimensional cardinality space. We chose two representative queries for each distinct plan. Hence, for each distinct plan, one query whose constants were closest (in terms of Euclidian distance) to the origin and one that was the farthest may be picked. These queries are believed to represent two extremes for a particular plan. Using this approach, the number of queries in the regression suite 114 is at most 42*2=84.

It may be desirable to recompile these representative queries to allow examination of the plan generation process and evaluation of whether all of the intermediate cardinalities are close to being accurate. Otherwise, the plans generated cannot be relied on. It is also desirable to force alternate plans on at least a few of these queries to make sure that the plans picked by the optimizer are indeed optimal or close to optimal. If feasible, the above checks should be performed on all queries in the regression suite. This is feasible when the number of tables is small. The accuracy of cardinality estimates and the optimality of query plans is not an essential aspect of an exemplary embodiment of the present invention.

In an exemplary embodiment of the present invention, a relatively simple quantitative metric may be chosen to evaluate the effectiveness of the regression suite 114. M is defined as n/N where n is the number of plans covered by the suite and N is the total number of possible plans. In the example set forth above, M=42/125=0.336. Intuitively, the higher the value of M, the better the quality of the regression suite 114 because a higher value of M implies that the regression suite 114 covers more of the optimizer plan space.

Those of ordinary skill in the art will appreciate that different regression suites derived from the same skeleton query using different cardinality sets are going to be partially ordered. Thus, the metric M is not a sufficient basis on which to decide the quality of the regression suite 114. It may be desirable for the queries in the regression suite 114 to have relatively different plans. In one exemplary embodiment of the present invention, hash joins should not dominate most of the plans. It would be desirable for the metric to take into account the diversity of the plans of the queries in the regression suite 114.

The following discussion relates to the extension of an exemplary embodiment of the present invention to non-linear join graphs. In the examples given above, the regression suite queries were based on a skeleton join query having a linear join graph. Alternatively, a regression suite according to an exemplary embodiment of the present invention may be developed for star join queries by starting with a star join skeleton query. Moreover, one approach might be to pick different skeleton queries with an appropriate underlying ‘geometry’ for different query types. It should be noted that this process could be relatively cumbersome for larger numbers of query types.

Alternatively, a fully connected join graph on four tables may be used rather than using different skeleton queries for different types of join queries. This generalized skeleton query is shown below:
select T₁.a
from T T₁, T T₂, T T₃, T T₄
where T₁.a=T₂.a and T₂.c=T₃.c and T₃.d=T₄.d
and T₁.e=T₃.e and T₁.f=T₄.f and T₂.g=T₄.g
and T₁.b≦C₁ and T₂.b≦C₂ and T₃.b≦C₃ and T₄.b≦C₄

In addition, it may be desirable to extend the schema of T by adding columns e, f, and g. For this example, the complete schema is:
T (int a, int b, int c, int d, int e, int f, int g)
a: primary clustering key, hash partitioned 8 ways on column ‘a’
b: unique random secondary key
c: Beta (4, 4): integer-valued, Normal-like over [1, 8388608] with mean=4194419, std. dev=1398131
d: Beta (2, 0.5): integer-valued, Zipfian-like over [1, 8388608] with mean=6711152, skew=−1.25
e: uniformly distributed between 1 and 256
f: uniformly distributed between 1 and 4096
g: uniformly distributed between 1 and 65536
   Each of the columns b thru g has a secondary index.

The queries are now generated by including different subsets of join edges, starting from no predicates to including all the predicates. Thus, all types of join queries on four tables are included with one skeleton query including star joins. This concept may be applied to any number of tables.

As another example, queries may be generated using CardSet₁ with five cardinality values. Using the generalized skeleton query, the total number of queries generated was 2^{(4C}₂⁾*5^{4=40,000}. This is because there are a total of 2^{(4C}₂⁾=64 subsets of join predicates including the empty subset.

When the 40,000 queries using CardSet₁ were compiled, the result was 93 distinct plans. The 640,000 (=2^{(4C}₂⁾*10⁴) queries using CardSet₂ were compiled to obtain 101 plans. The increase in the number of queries using CardSet₂ was rather small, suggesting that a coarse division of the cardinality space is sufficient to capture most of the plans if a high quality skeleton query is used as a starting point.

In this example, the metric value of M=101/125=0.808. This is a significant improvement over the previous example in which a metric of M=0.336 was obtained with a linear skeleton query. For each distinct plan, two representatives may be chosen as described above.

According to an exemplary embodiment of the present invention, the number of queries generated using a generalized skeleton query is ‘doubly’ exponential. If the number of tables is t and the number of cardinality values is c, then the number of generated queries is 2^{(tC}₂⁾* c^{t}. With t=c=5, this number is 640,000. If queries are generated with t=5 and c=10, this number would be 102.4 million. Another approach might be to use an appropriately-sized random sample of the generated queries to obtain the plans. This may help in reducing the compilation time, if that is a concern. Alternately, the values for C₁ thru C₄ could be generated randomly.

As set forth above TPC-H and TPC-DS are known data warehousing benchmarks. Those of ordinary skill in the art will appreciate that TPC-H has 22 queries and TPC-DS has 99 queries. Several of the TPC-DS queries are complex, having multiple parts and spanning several pages. Because of the complexity of the DS queries, many of which are joins of views (‘with expressions’), many DS plans are inherently bushy. According to an exemplary embodiment of the present invention, only plan signatures from the zig-zag parts of the DS plans need be captured for the reasons set forth above.

Because a regression suite according to an exemplary embodiment of the present invention employs three joins in each query, it is only necessary to consider TPC-H and TPC-DS queries having plan signatures with at least three joins in them (after being un-nested). An exemplary embodiment of the present invention was tested in which an optimizer did not support all parts of all of the TPC-DS queries. As a result, nine plans were retained from the TPC-H benchmark and 90 plans were retained from the TPC-DS benchmark. The number of distinct sequences of three consecutive joins was counted. For a query with j joins, (j-2) sequences of three consecutive joins are obtained.

A zig-zag plan with the following six joins was considered: J₂-J₂-J₃-J₁-J₄-J₅. The four contiguous sequences of three joins obtained from this plan are J₂-J₂-J₃, J₂-J₃-J₁, J₃-J₁-J₄, and J₁-J₄-J₅. Therefore, a single suite, contribute more than one plan to the metric.

The number of such distinct sequences of three joins was 17 in the TPC-H plans and 61 in the TPC-DS plans. These numbers are lower than 101, the number of distinct plans for the queries generated for a regression suite in an example above. When both of these suites are combined into a single suite, which may be referred to as the HDS suite, the number of distinct plans increased slightly to 67. It may be noted that a 50% increase (67 to 101) in coverage of the plan space is believed to be significant. Moreover, after a certain point, the effort to capture each additional plan would increase significantly if queries need to be generated manually.

In one exemplary embodiment of the present invention, the set of query plans of the generated queries was not a super set of the plans in the HDS suite. The latter had seven additional plans, each having at least one merge join. This is believed to be attributable to the fact that only one join predicate (T₁.a=T₂.a) in the generated queries was on a sorted column. This may be addressed by generating a few queries manually.

The exact number of distinct plans captured by each suite will vary depending on the optimizer. The HDS queries, some of which are highly complex were observed to exhibit less diversity in terms of plan coverage when compared to a systematically generated regression suite made up of very simple queries. Those of ordinary skill in the art will appreciate that the time and effort needed to create benchmarks such as the TPC-DS is very large compared to automatically generating a regression suite according to an exemplary embodiment of the present invention, which may be accomplished for some optimizers in a few hours. As an illustration, the TPC-DS benchmark has 24 tables and that have a total of 396 columns. A regression suite according to an exemplary embodiment of the present invention may be constructed using one table with seven integer columns.

Another problem with employing complex queries is that it is difficult to know if a better plan exists. This makes the use of complex queries in a regression suite less valuable. With simple queries based on a small number of instances of tables, better plans can be found by trying a few alternatives.

An additional issue relates to how to cover an operator space. It would be desirable to use as many patterns of operators in the plans as possible. The physical operators that will be chosen or not chosen by the optimizer is determined by the choice of the skeleton query. For example, the generalized skeleton query set forth above will not produce the UNION operator. To get more operators included in the plans of the regression queries, a skeleton query consisting of several logical operators may be chosen. This would make the skeleton query more complex, which in turn would make it much harder to decide if the plans generated are indeed optimal. In order to keep the queries simple, it may be desirable to devise rules to partition the physical operator space. Operators in different partitions that do not affect each other, both from the costing perspective as well as during execution, can be dealt with independently. This would lead to simpler skeleton queries.

Alternately, a ‘master’ skeleton query could be devised having several logical operations in it. The generation process could selectively choose different parts of the skeleton query. This is similar to what was done with the generalized join query in the example set forth above, in which different subsets of join predicates were chosen.

It may be desirable to focus on the very large plan spaces alluded to herein. Most commercial database systems have several operators with multiple variations for each operator, which results in a very large plan space. A 1-1 mapping from the plans to the regression queries is not practical in these cases. It is desired to provide a small number of regression queries such that each plan could contribute more than one plan pattern. Moreover, the union of these plan patterns will desirably constitute a significant portion of the plan space.

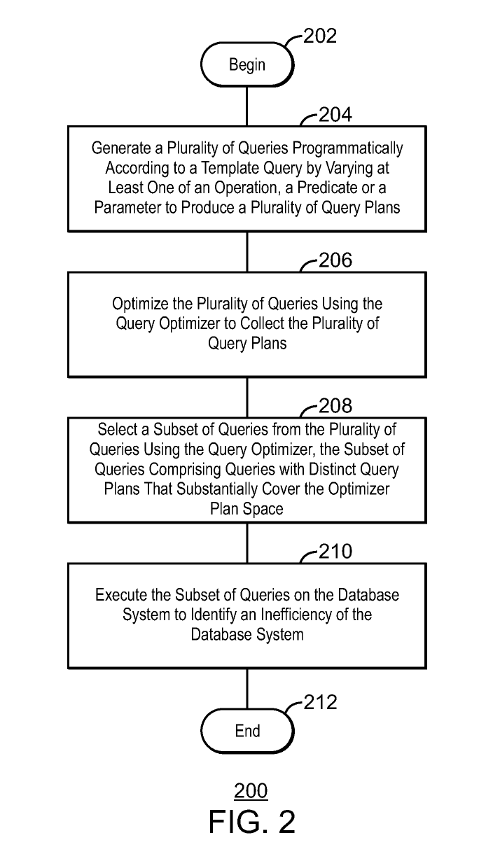

FIG. 2 is a process flow diagram showing a computer-implemented method for performing testing on a database system according to an exemplary embodiment of the present invention. The database system comprises a query optimizer that has an optimizer plan space comprising a plurality of query plans. The method is generally referred to by the reference number 200.

The method begins at block 202. At block 204, a plurality of queries is generated programmatically according to a template query by varying at least one of an operation, a predicate or a parameter to produce a plurality of query plans. At block 206, the plurality of queries is optimized using the query optimizer to collect the plurality of query plans. A subset of queries is selected from the plurality of queries using the query optimizer, as shown at block 208. The subset of queries comprises queries with distinct query plans that substantially cover the optimizer plan space. At block 210, the subset of queries is executed on the database system to identify an inefficiency of the database system. At block 212, the process ends.

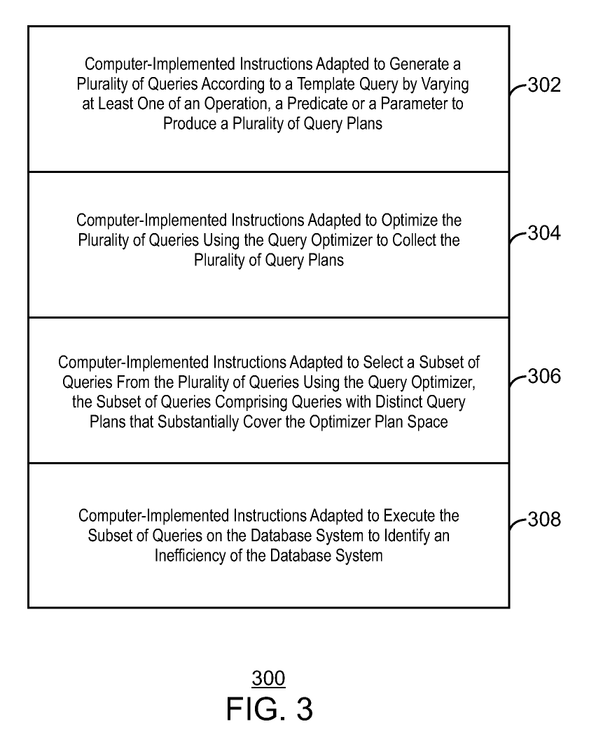

FIG. 3 is a block diagram showing a tangible, machine-readable medium that stores code adapted to facilitate the performance of testing on a database system according to an exemplary embodiment of the present invention. The tangible, machine-readable medium is generally referred to by the reference number 300. The tangible, machine-readable medium 300 may correspond to any typical storage device that stores computer-implemented instructions, such as programming code or the like. Moreover, the tangible, machine-readable medium 300 may comprise the memory 106 shown in FIG. 1. When read and executed by a processor such as the processor 102 shown in FIG. 1, the instructions stored on the tangible, machine-readable medium 300 are adapted to cause the processor to perform testing on a database system comprising a query optimizer. In one exemplary embodiment of the present invention, the query optimizer has an optimizer plan space comprising a plurality of query plans.

A first region 302 of the tangible, machine-readable medium 300 stores computer-implemented instructions adapted to generate a plurality of queries programmatically according to a template query by varying at least one of an operation, a predicate or a parameter to produce a plurality of query plans. A second region 304 of the tangible, machine-readable medium 300 stores computer-implemented instructions adapted to optimize the plurality of queries using the query optimizer to collect the plurality of query plans. A third region 306 of the tangible, machine-readable medium 300 stores computer-implemented instructions adapted to select a subset of queries from the plurality of queries using the query optimizer. The subset of queries comprises queries with distinct query plans that substantially cover the optimizer plan space. A fourth region 308 of the tangible, machine-readable medium 300 stores computer-implemented instructions adapted to execute the subset of queries on the database system to identify an inefficiency of the database system.

As set forth herein, an exemplary embodiment of the present invention relates to a systematic method of generating a regression suite that tries to substantially capture the optimizer plan space. Generating regression queries in this manner is likely to cover a larger portion of the plan space than an arbitrary set of suites. The actual number of queries compiled to generate the regression suite may be large, but this process is relatively infrequent and can be completely automated. It may be desirable to re-generate the regression suite if the optimizer cost functions change substantially. The final regression suite itself includes a small number of simple queries that provide fairly complete coverage of the plan space resulting in a relatively economical regression testing process. This is important because the regression queries may be compiled over and over again for every build or release of the optimizer. In addition to generating regression queries, exemplary embodiments of the present invention may be adapted to test the cost functions of a new or existing cost model to identify inefficiencies therein.

What is claimed is:

1. A computer-implemented method of testing a database system comprising a query optimizer, the query optimizer having an optimizer plan space comprising a plurality of query plans, the method comprising:
generating a plurality of queries programmatically according to a template query by varying at least one of an operation, a predicate or a parameter to produce a plurality of query plans;
optimizing the plurality of queries using the query optimizer to collect the plurality of query plans;
selecting a subset of queries from the plurality of queries using the query optimizer, the subset of queries comprising queries with distinct query plans that substantially cover the optimizer plan space; and
executing the subset of queries on the database system to identify an inefficiency of the database system.

2. The method recited in claim 1, comprising determining whether the subset of query plans substantially covers the optimizer plan space.

3. The method recited in claim 2, comprising generating a larger number of queries by varying the parameter with a higher degree of resolution if the plurality of query plans does not substantially cover the optimizer plan space.

4. The method recited in claim 1, wherein the operation comprises a scan operation, a join operation or a group by operation.

5. The method recited in claim 1, comprising selecting at least one representative query for each of the plurality of query plans.

6. The method recited in claim 1, comprising simplifying the template query by removing at least one operation from the template query.

7. The method recited in claim 1, comprising sampling the plurality of queries to obtain the subset of queries.

8. The method recited in claim 1, comprising manually adding an additional query plan having a particular characteristic to the subset of query plans if the subset of query plans does not include a query plan with the particular characteristic.

9. The method recited in claim 1, comprising selecting the template query to correspond to a schema of the database system.

10. The method recited in claim 1, wherein the inefficiency comprises a regression.

11. A computer system for performing regression testing on a database system comprising a query optimizer, the query optimizer having an optimizer plan space comprising a plurality of query plans, the computer system comprising:
a processor that is adapted to execute stored instructions; and
a memory device that stores instructions that are executable by the processor, the instructions comprising:
computer-implemented code adapted to generate a plurality of queries according to a template query by varying at least one of an operation, a predicate or a parameter to produce a plurality of query plans;
computer-implemented code adapted to optimize the plurality of queries using the query optimizer to collect the plurality of query plans;
computer-implemented code adapted to select a subset of queries from the plurality of queries using the query optimizer, the plans that substantially cover the optimizer plan space; and
computer-implemented code adapted to execute the subset of queries on the database system to identify an inefficiency of the database system.

12. The computer system recited in claim 11, comprising computer-implemented code adapted to determine whether the subset of query plans substantially covers the optimizer plan space.

13. The computer system recited in claim 12, comprising computer-implemented code adapted to generate a larger number of queries by varying the parameter with a higher degree of resolution if the plurality of query plans does not substantially cover the optimizer plan space.

14. The computer system recited in claim 11, wherein the operation comprises a scan operation, a join operation or a group by operation.

15. The computer system recited in claim 11, comprising computer-implemented code adapted to select at least one representative query for each of the plurality of query plans.

16. The computer system recited in claim 11, comprising computer-implemented code adapted to simplify the template query by removing at least one operation from the template query.

17. The computer system recited in claim 11, comprising computer-implemented code adapted to sample the plurality of queries to obtain the subset of queries.

18. The computer system recited in claim 11, wherein the template query is selected to correspond to a schema of the database system.

19. The computer system recited in claim 11, wherein the inefficiency comprises a regression.

20. A tangible, machine-readable medium that stores machine-readable instructions executable by a processor to perform testing on a database system comprising a query optimizer, the query optimizer having an optimizer plan space comprising a plurality of query plans, the tangible, machine-readable medium comprising:
machine-readable instructions that, when executed by the processor, generate a plurality of queries according to a template query by varying at least one of an operation, a predicate or a parameter to produce a plurality of query plans;
machine-readable instructions that, when executed by the processor, optimize the plurality of queries using the query optimizer to collect the plurality of query plans;
machine-readable instructions that, when executed by the processor, select a subset of queries from the plurality of queries using the query optimizer, the subset of queries comprising queries with distinct query plans that substantially cover the optimizer plan space; and
machine-readable instructions that, when executed by the processor, execute the plurality of queries on the database system to identify an inefficiency of the database system.
